(19) United States
(12) Patent Application Publication
(10) Pub. No.: US 2012/0310719 A1
(43) Pub. Date: Dec. 6, 2012

(54) VARIABLE VALUE COUPONS

(76) Inventors: Diane R. Hammerstad, Corvallis, OR (US); Kimberly J. Kaaz, Albany, OR (US)

(21) Appl. No.: 13/149,815

(22) Filed: May 31, 2011

(51) Int. Cl. G06Q 30/00

(52) U.S. Cl. 705/14.25; 705/14.1; 705/14.39

(57) ABSTRACT

In one embodiment, a coupon is created. The coupon includes a delivery date and data associated with a variable value schema, the schema dependent upon an elapsed time between the delivery date and redemption of the coupon.

### BACKGROUND

Incenting consumers via coupons is a method manufacturers and retailers utilize to motivate consumers to purchase a product. A coupon may be in a hard copy form that a consumer physically delivers to a manufacturer, retailer or other redeeming entity (hereinafter a “redeeming entity”) to redeem the coupon. Alternatively, a coupon may be in the form of an image that is stored on the consumer's electronic device and electronically provided by the consumer to the redeeming entity for redemption.

### BRIEF DESCRIPTION OF THE DRAWINGS

The accompanying drawings illustrate various embodiments and are a part of the specification. The illustrated embodiments are examples and do not limit the scope of the claims. Throughout the drawings, identical reference numbers designate similar, but not necessarily identical elements.

FIG. 1 depicts the logical components of a coupon manager according to an embodiment.

FIGS. 2-4 depict examples of various physical and logical components for implementing various embodiments.

FIGS. 5 and 6 are example flow diagrams depicting steps taken to implement various embodiments.

FIGS. 7A and 7B are examples of variable value coupons.

The same part numbers designate the same or similar parts throughout the figures.

### DETAILED DESCRIPTION OF EMBODIMENTS

With traditional coupons, a manufacturer, merchant or entity providing coupons (hereinafter a “coupon provider”) may make an educated forecast about the motivations and buying habits of a group of consumers, and then set a redemption value and an expiration date for coupons in accordance with the forecast. With this approach, however, there can be a high number of unredeemed or slowly redeemed coupons. Unredeemed and slowly redeemed coupons can be costly for the coupon provider in terms of lost sales revenue, increased inventory, and expenses relating to the creation and distribution of the unredeemed coupons.

Various embodiments described below were developed in an effort to create a new method and system to produce variable value coupons that are attractive to coupon users and may result in higher redemption percentage and/or faster redemption rates. The embodiments shown in the accompanying drawings and described below are non-limiting examples. Other embodiments are possible and nothing in the accompanying drawings or in this Detailed Description of Embodiments should be construed to limit the scope of the disclosure, which is defined in the Claims.

In an embodiment, a coupon is created that includes a delivery date, and a variable value schema or an address for electronic access to the schema. The delivery date and variable value schema data may be read and utilized by the redeeming entity to determine a final value for the coupon at the time of redemption. The value of the variable value coupon at the time of redemption is dependent upon the elapsed time between delivery of the coupon and the redemption date.

In embodiments, a coupon is created that includes a variable value schema that is selected based upon information known about that a coupon user or set of coupon users (hereinafter “coupon user information”). In other embodiments, the variable value schema is selected from a set of available schemes based upon market information or inventory information. In certain embodiments, data indicative of actual redemption dates for coupons is received, and that data is used to modify the set of variable value schemas. The modified schemes may be utilized as new coupons are issued. In certain embodiments, the modified schema may be used to update a schema that is included in, or referenced by, an existing coupon.

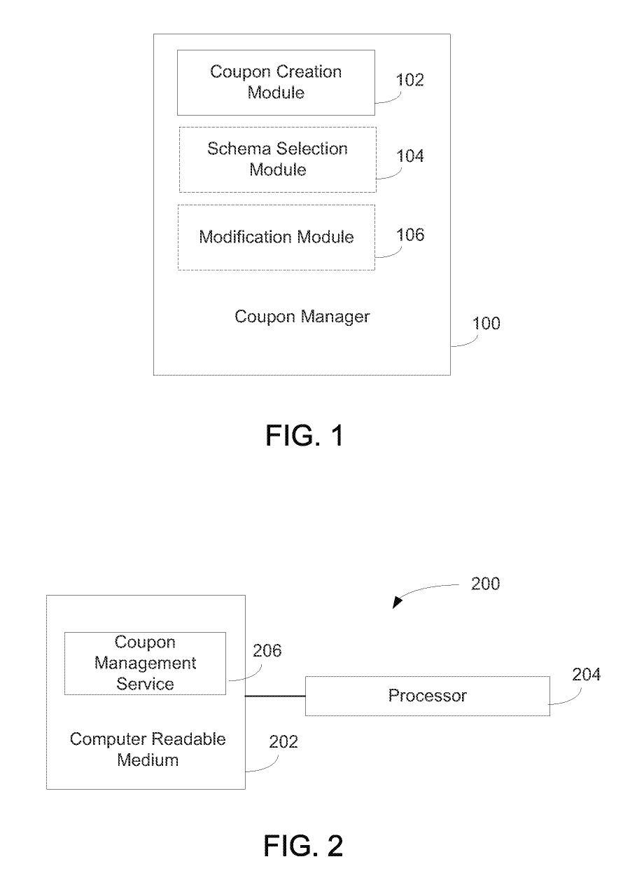

The diagrams of FIGS. 1-4 are used to depict the architecture, functionality, and operation of various embodiments. Various components illustrated in FIGS. 1-4 are defined at least in part as programs. Each such component, portion thereof, or various combinations thereof may represent in whole or in part a module, segment, or portion of code that comprises one or more executable instructions to implement any specified logical function(s). Each component or various combinations thereof may represent a circuit or a number of interconnected circuits to implement the specified logical function(s).

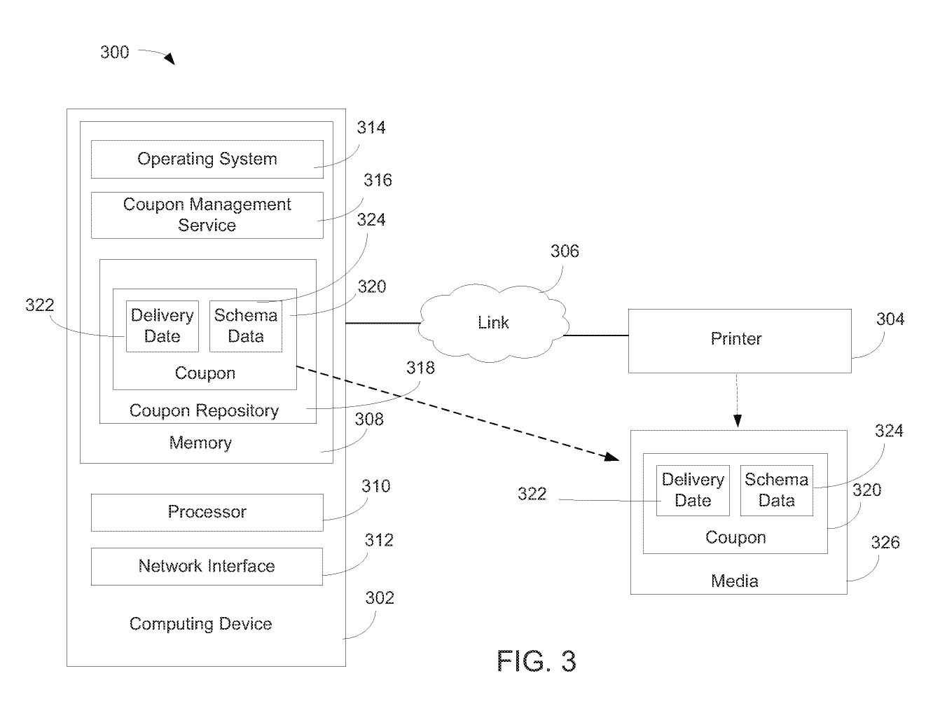

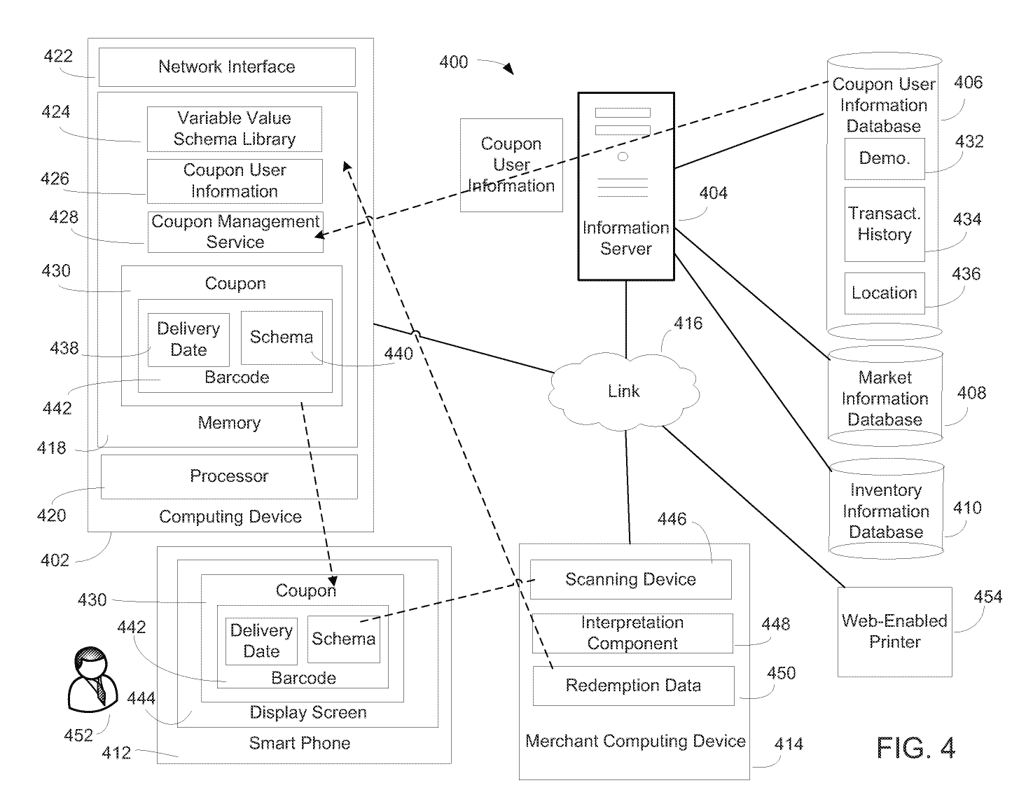

FIG. 1 is an example block diagram illustrating the logical components of a coupon manager 100. Coupon manager 100 represents generally any combination of hardware and programming configured to produce variable value coupons. Coupon manager 100 may be implemented in a number of environments, such as environment 200 of FIG. 2, environment 300 of FIG. 3, and environment 400 of FIG. 4. In the example of FIG. 1, coupon manager 100 includes a coupon creation module 102, schema selection module 104, and modification module 106.

As used in this specification, a “coupon” means generally a certificate, voucher, document, instrument, writing, image, or other display of information that that entitles a recipient to receive a benefit, e.g., a discount, refund, reward, gift, money, or other thing or service. A “variable value coupon” means generally a coupon with a redemption value that may change dependent upon a condition. “Redemption value” and “value” are used synonymously. A “variable value schema” means generally a plan, pattern, structure, or outline for determining a variable value for a coupon. “Redemption” of a coupon means generally acceptance or honoring of a coupon such that the party presenting the coupon is afforded a benefit attached to or associated with the coupon. “Encoded” means generally presented in a format that is generally not readable by a human without the aid of a machine. “Digital watermark” means generally an image with an embedded digital signal.

Coupon creation module 102 represents generally any combination of hardware and programming configured to create a coupon that includes a delivery date and data associated with a variable value schema. In an embodiment, the coupon is a hard copy coupon printed upon a paper or other media. In another embodiment, the coupon is an electronic image that is displayable via an electronic display device, such as a display device of a smart phone or other mobile computing device. The variable value schema is utilized to determine a value of the coupon at redemption time that is dependent upon an elapsed time between the delivery date and date of redemption of the coupon.

In an embodiment delivery date is a calendar day or reference, e.g. March 1, Mar. 1, 2011, or 1 MAR, etc. In another embodiment, a delivery date may be, or include, a time, e.g., 3:00 pm, or 3:00 pm, March 1, or 3:00 pm, Mar. 1, 2011, etc. In an embodiment, the data included in the coupon is the variable value schema itself. In another embodiment, the data included in the coupon includes an address (e.g., a hyperlink, or a URL that can be loaded into a web browser) that provides electronic access to a schema that resides on a server accessible via the internet or another network. In embodiments, the schema includes a formula or lookup table. In an embodiment, the schema is displayed in a text and/or numeric form such that a person observing the coupon can discern the details of the variable coupon offer. In an example of a hard copy coupon, the schema may be printed upon the media. In an example of a coupon that is an electronic image (sometimes referred to herein as an “electronic coupon”), the schema may be displayed as part of the coupon on a display screen connected to, or incorporated within, a computing device.

In an embodiment, at least one of the delivery date, the schema, or the address, is in an encoded format. By encoding the delivery date, the schema, and/or the address it may be possible to present more information regarding the coupon than could be presented via printing on the hard copy coupon, or than could readably displayed on a display device. Also, by utilizing encoding, it is possible to provide some portion of the data to the redeeming entity at redemption time without being visible to the coupon user. For example, it may desirable in some situations to include all of the details of the variable value schema within the coupon, yet not desirable to print or display all of the information on the face of the coupon for aesthetic or space-saving reasons.

In an example, encoded formatting for the delivery date, schema, or address includes a barcode. Examples of barcodes include, but are not limited to, linear barcodes (1D barcodes), rectangles, dots, hexagons and other geometric patterns in two dimensions (2D barcodes), and barcodes in which a third dimension (such as a color variation or a tactile variation) is considered in addition to the geometric patterns present in a 2D barcode (3D barcodes). Examples of 1D barcodes are EAN and UCC barcodes. Examples of 2D barcodes are OR codes, GS1 Databars, PDF 417s, data matrixes, maxicodes, Microsoft® tags and Aztec codes.

In an example, encoded formatting for the delivery date, schema, or address includes a digital watermark. The digital watermark may be in a “visible” or “invisible” format. In “visible” digital watermarking, the encoded information may be included as signal in the digital image in a manner that is visible to, but not readable by, the coupon user. With “invisible” digital watermarking, the encoded data may be included as signal within the digital image that it is generally not visible to the coupon user.

In an embodiment, after the creation of the variable value coupon, the coupon is printed as a hard copy coupon. In another embodiment, after the creation of the variable value coupon, the coupon is sent to a coupon user's computing device as an electronic image file. In another embodiment, after the creation of the variable value coupon, the coupon is sent as an electronic image file to web page that is accessible to the coupon user's computing device. If the coupon user's computing device is a mobile computing device, the coupon user may present the coupon for redemption by displaying the coupon image to a redeeming entity via the display element. If the coupon includes encoded data, e.g., a barcode or digital watermark, the redeeming entity may utilize an optical scanner or image capture device to attain, acquire, or capture a copy of the encoded data. The redeeming entity may then interpret the coupon's final redemption value by utilizing a computing device with programming to decode the encoded data. In another embodiment, the coupon user may send the coupon in an electronic file format to the redeeming entity for redemption via email or other electronic delivery means.

In an embodiment, coupon manager 100 additionally includes a schema selection module 104. Schema selection module 104 represents generally any combination of hardware and programming configured to store a set of variable value schemas for a coupon, and to receive information relating a coupon user (sometimes referred to herein as “coupon user information”). In consideration of the coupon user information, a first schema is selected from the set of available schemas.

In an embodiment, the set of variable value schemas is stored at a memory within the same computing device that receives the coupon user information and executes the programming that selects a first schema to be included within the coupon. In another embodiment, the set of schemes is stored at a database that is separate from, but accessible to, the computing device that receives the coupon user information and selects the first schema.

In an embodiment, the coupon user information that is received and that is considered in the selection of a schema includes demographic information. Examples of demographic information include, but are not limited to, gender, age, income, address, commute time, number of vehicles in the household, education, home ownership, and employment status. In an example, the coupon user information that is received and considered in the selection of a schema is transaction history information, e.g., a record of previous transactions in which the coupon user was a participant.

In an embodiment, the coupon user information that is received and that is considered in the selection of a schema is usage or purchase information relating to a printer, e.g., printers utilized, or printer supplies. In an embodiment, the information is printer supplies usage or purchase information received via a web-enabled printer. In an embodiment, the information is demographic information obtained from a user via a web-enabled printer. In an embodiment, the coupon user information is information obtained via the coupon user's interaction with a web application, e.g., interaction with a web application at a web-enabled printer.

In another example, the coupon user information that is received and considered in the selection of a schema is a current or recent location of the coupon user as indicated by a global positioning system (“GPS”), satellite navigation system, or other location-identifying means.

In other embodiments, market information or inventory information relating to a product or service that is a subject of the coupon is received and considered in selecting a schema. Examples of “market’ information include, but are not limited to, product demand forecasts, consumer purchasing indices, consumer price indices, and debt and equity market indices. Examples of “inventory’ information include, but are not limited to, product or raw material inventory levels of a coupon provider, inventory levels of manufacturers or merchants associated with the coupon provider, or inventory levels of entities unrelated to the coupon provider.

In an embodiment, coupon manager 100 additionally includes a modification module 106. Modification module 106 represents generally any combination of hardware and programming configured to receive data indicative of an actual redemption date for a variable value coupon. In an embodiment, responsive to receipt of such data, a value schema or a set of variable value schemes is modified. In another embodiment, responsive to receipt of such data, stored information relating to a coupon user (e.g., a database of coupon user information) is modified. By regularly modifying the variable value schema and updating the database of coupon user information in response to actual redemption data, a merchant can refine a coupon campaign and improve the redemption percentage and/or redemption rate for coupons issued pursuant to the campaign.

Coupon manager 100 may be implemented in a number of environments, such as environment 200 of FIG. 2. Environment 200 includes a computer readable medium 202, and a processor 204. In a given implementation, computer readable medium 202 may represent multiple computer readable media and processor 204 may represent multiple processors.

Computer readable medium 202 represents generally any medium that can contain, store, or maintain programs and data for use by or in connection with an instruction execution system. Computer readable medium can include any one of many physical media such as, for example, electronic, magnetic, optical, electromagnetic, or semiconductor media. More specific examples of suitable computer-readable media include, but are not limited to, hard drives, random access memory (RAM), read-only memory (ROM), erasable programmable read-only memory, flash drives, compact discs, and digital video discs. In an embodiment, a number of software components are stored in the computer-readable medium 202 and are executable by processor 204. In this respect, the term “executable” includes a program file that is in a form that can be directly (e.g., machine code) or indirectly (e.g., source code that is to be compiled) performed by the processor 204. An executable program may be stored in any portion or component of computer readable medium 202.

Processor 204 represents generally any instruction execution system, such as a computer/processor based system or an ASIC (Application Specific Integrated Circuit), a computer, or other system that can fetch or obtain instructions or logic from computer-readable medium 202 and execute the instructions or logic contained therein.

Computer readable medium 202 is shown to include coupon management service 206. Coupon management service 206 represents generally any programming, that, when executed, implements the functionality of the coupon manager 100 of FIG. 1. In an embodiment, coupon management service 206, when executed by processor 204, is responsible for creating a coupon that includes a delivery date and data associated with a variable value schema. The coupon may be created in hard copy form, or as an electronic image that is displayable via an electronic display device. The variable value schema can be utilized by a redeeming entity to determine a value of the coupon at redemption time that is dependent upon an elapsed time between the delivery date and redemption of the coupon. In an embodiment, a set of potential variable value schemas for a coupon is stored at a memory element, and information is received relating a coupon user. A first schema is selected from the set of potential schemas In consideration of the coupon user information. In another embodiment, data is received that is indicative of an actual redemption date for a variable value coupon. Responsive to receipt of such data, a value schema and/or previously received coupon user information can be modified to increase the success of a coupon program or campaign.

Coupon manager 100 may also be implemented in an environment such as environment 300 of FIG. 3. Environment 300 is shown to include a computing device 302 and a printer 304 interconnected via link 306.

Computing device 302 includes a memory 308, a processor 310, and a network interface 312. In a given implementation, memory 308 may represent multiple memories, and processor 310 may represent multiple processors. In embodiments, computing device 302 may be a desktop computer, laptop computer, server, mobile computing device, smart phone, tablet computer, or any other computing device. In an embodiment, the computing device 302 may include a number of software components that are stored in a computer-readable medium, such as memory 304, and are executable by processor 310.

Processor 310 represents generally any instruction execution system, such as a computer/processor based system or an ASIC (Application Specific Integrated Circuit), a computer, or other system that can fetch or obtain instructions or logic from memory 304 and execute the instructions or logic contained therein.

Memory 308 is shown to include operating system 314, coupon management service 316, and coupon repository 318. Operating system 314 represents generally any software platform on top of which other programs or applications such as interactive document build service 314 run. Examples include Linux® and Microsoft® Windows. Coupon repository 318 represents generally a collection of coupons stored in memory 308. In this example, the document repository holds a single coupon 320, but could hold a plurality of coupons.

Coupon management service 316 represents generally any programming, that, when executed, implements the functionality of the coupon manager 100 of FIG. 1. In particular, coupon management service 316, when executed by processor 310, is responsible for creating a coupon 320 that includes a delivery date 322, and data 324 associated with a variable value schema. At redemption time, the variable value schema data 324 can be utilized to determine a value of the coupon 320 that is dependent upon an elapsed time between the delivery date 322 and the redemption of the coupon 320. In an embodiment, the schema data 324 included in the coupon is the variable value schema itself. In another embodiment, the schema data 324 included in the coupon 320 includes an address (e.g., a hyperlink, or a URL that can be loaded into a web browser) that provides electronic access to a schema that resides on a server accessible via the internet or another network. In embodiments, the schema data 324 includes a formula or lookup table for calculating a redemption value based on elapsed time between the delivery date 322 and the redemption date.

After the creation of the variable value coupon 320 in memory 308, the coupon 320 is caused to be printed at a printer 304 upon a media 326 to produce a hard copy coupon. A coupon user may then tender the hard copy of the coupon to a redeeming entity, which redeeming entity will utilize the delivery date 322 and the schema data 324 to discern a redemption value for the variable value coupon 320. In an embodiment, the redeeming entity can interpret the coupon's redemption value via reading the delivery date 322 and schema data 324 as text on the face of the coupon face, without the need for decoding.

Printer 304 represents generally any computing device operable to receive and process responses to requests to print content and to produce printed output. In embodiments printer 304 may be an inkjet, laser, piezoelectric, or any other type of electronic printing device. Printer 304 is capable of receiving messages, including but not limited to print jobs, from computing device 302.

Network interface 312 represents generally any combination of hardware and programming configured for electronically connecting computing device 302 to link 306. In an embodiment, the network interface 312 may include a network interface card, a network adapter, a network interface controller, and or a LAN adapter. Network requests may be sent and received utilizing a networking protocol, including but not limited to Transmission Control Protocol/Internet Protocol (“TCP/IP”), HyperText Transfer Protocol (“HTTP”), Simple Mail Transfer Protocol (“SMTP”), Extensible Messaging and Presence Protocol (“XMPP”) and/or Session Initiation Protocol (“SIP”).

Link 306 represents generally one or more of a cable, wireless, fiber optic, or remote connection via a telecommunication link, an infrared link, a radio frequency link, or any other connectors or systems that provide electronic communication. Link 306 may include, at least in part, an intranet, the internet, or a combination of both. Link 306 may also include intermediate proxies, routers, switches, load balancers, and the like. The paths followed by link 306 between computing device 302 and printer 304 as depicted in FIG. 3 represent the logical communication paths between these devices, not necessarily the physical paths between the devices.

Coupon manager 100 may also be implemented in an environment such as environment 400 of FIG. 4. Environment 400 includes a computing device 402, information server 404, coupon user information database 406, market information database 408, inventory information database 410, smart phone 412, merchant computing device 414, and web-enabled printer 454 interconnected via link 416.

Computing device 402 includes a memory 418, a processor 420, and a network interface 422. In a given implementation, memory 418 may represent multiple memories, and processor 420 may represent multiple processors. In an embodiment, the computing device 402 may include a number of software components that are stored in a computer-readable medium, such as memory 418, and are executable by processor 420.

Processor 420 represents generally any instruction execution system, such as a computer/processor based system or an ASIC (Application Specific Integrated Circuit), a computer, or other system that can fetch or obtain instructions or logic from memory 418 and execute the instructions or logic contained therein.

Memory 418 is shown to include variable value schema library 424, coupon user information 426, coupon management service 428, and coupon 430. Variable value schema library 424 represents generally a plurality of available variable value schema for coupons 430 that are stored at memory 418. Coupon user information 426 represents generally information regarding a coupon user 452. In an embodiment, the coupon user information 426 is information that is accumulated at computing device 402 via interactions with coupon user 452 (e.g., communications or data received from coupon user 452 via smart phone 412). In another embodiment, the coupon user information is received from a coupon user information database 406, either directly, or indirectly via an information server computing device 404. In embodiments, the coupon user information 426 may include demographic information 432, transaction history information 434 or location information 436, e.g., information regarding a current location of the coupon user 452.

Coupon management service 428 represents generally any programming, that, when executed, implements the functionality of the coupon manager 100 of FIG. 1. In particular, coupon management service 428, when executed by processor 420, is responsible for creating a coupon 430 that includes a delivery date 438, and a variable value schema 440. The variable value schema 440 is utilized to determine a value of the coupon 430, at redemption time, that is dependent upon an elapsed time between the delivery date 438 and redemption of the coupon 430. In this embodiment, the delivery date 438 and the schema 440 are in an encoded format that includes a barcode 442. In embodiments, the schema 440 includes a formula or lookup table.

After the creation of the variable value coupon 430 in memory 418 of computing device 402, the coupon 430 is sent to the coupon user's smart phone 412 as an electronic image file. The coupon user 452 may present the coupon 430 for redemption by displaying the coupon 430 image to a redeeming entity, in this case a merchant computing device 414, via the smart phone's display screen 444. As the coupon 430 includes a barcode 442, the merchant computing device 414 may utilize a scanning device 446 to attain, acquire, or capture a copy of the barcode 442. The redeeming entity may then interpret the coupon's redemption value by utilizing an interpretation component 448 that includes programming to decode the barcode 442. In an embodiment, the decoding programming is obtained at interpretation component 448 via communication with the coupon management service 428. In another embodiment, decoding programming is present at interpretation component without any communication with coupon management service 428.

In the embodiment pictured in FIG. 4, a library 424 of variable value schemes for a coupon is stored at memory 418. The coupon management service 428 may consider the coupon user information 426 stored in memory 418 in selecting a first schema for coupon 430 from the library 424 of available schemes. In embodiments, market information 408 and inventory information 410 may additionally be considered in selecting a first variable value schema for the coupon 430 from the library 424. In embodiments, the market information 408 and inventory information 410 may accessed directly by coupon management service 428, or may be accessed indirectly an information server 404.

The coupon management service 428 may additionally consider coupon user information relating to a printer, e.g., printers utilized, or printer supplies. In an embodiment, the information is printer supplies usage or purchase information received via a web-enabled printer 454. In an embodiment, the information is demographic information obtained from the coupon user 452 via the web-enabled printer 454. In an embodiment, the coupon user information is information obtained via the coupon user's interaction with a web application, e.g., interaction with a web application accessible at a web-enabled printer 454. In embodiments, the coupon user information may be obtained by coupon management service 428 directly from web-enabled printer 454, or may be accessed indirectly via information server 404. “Accessible at a web-enabled printer” means that the application is available for selection and execution in a manner such that the results of the running of the application are visible to a user of web-enabled printer 454.

Coupon management service 428 receives redemption data 450 indicative of an actual redemption date for variable value coupon 430. Responsive to receipt of such redemption data 450, the library 424 of variable value schemes and the received coupon user information 426 are modified. This modification refines a coupon campaign in light of actual redemption data and thereby may improve the redemption percentage and/or redemption rate for coupons issued pursuant to the campaign.

Network interface 422 represents generally any combination of hardware and programming configured for electronically connecting computing device 402 to link 416. Link 416 represents generally one or more of a cable, wireless, fiber optic, or remote connection via a telecommunication link, an infrared link, a radio frequency link, or any other connectors or systems that provide electronic communication. Link 416 may include, at least in part, an intranet, the internet, or a combination of both. Link 416 may also include intermediate proxies, routers, switches, load balancers, and the like. The paths followed by link 416 between computing device 402, information server 404, smart phone 412, merchant computing device 414, and web-enabled printer 454 as depicted in FIG. 4 represent the logical communication paths between these devices, not necessarily the physical paths between the devices.

Web-enabled printer 454 represents generally a printer that can be connected to a web, so as to be capable of obtaining content, sending and receiving messages, and/or running applications via the web. As used in this specification and the appended claims, “web” means the Internet or an intranet. In an embodiment a web-enabled printer 454 may operate in a standalone mode without being connected to a host computing device. In another embodiment, web-enabled printer 454 may connect one or more hosts via a cable, wireless or other connection, or via the web. In an embodiment, a web enabled printer 454 may be a printer that is not itself connected to the web, but rather is connected to the web by virtue of being connected, e.g., via a cable or wireless connection, to a host computing device that is connected to the web.

In the foregoing discussion, various components were described as combinations of hardware and programming. Such components may be implemented in a number of fashions. In one example, the programming may be processor executable instructions stored on tangible memory media and the hardware may include a processor for executing those instructions. Thus, certain elements operating on the same device may share a common processor and common memory media. Components operating on different devices, then, may utilize different processors and memory media.

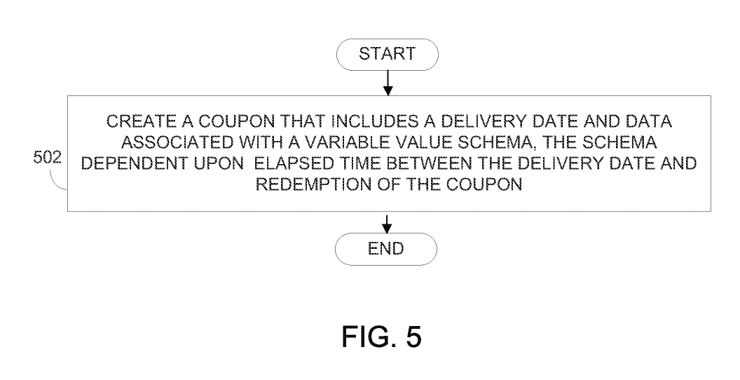

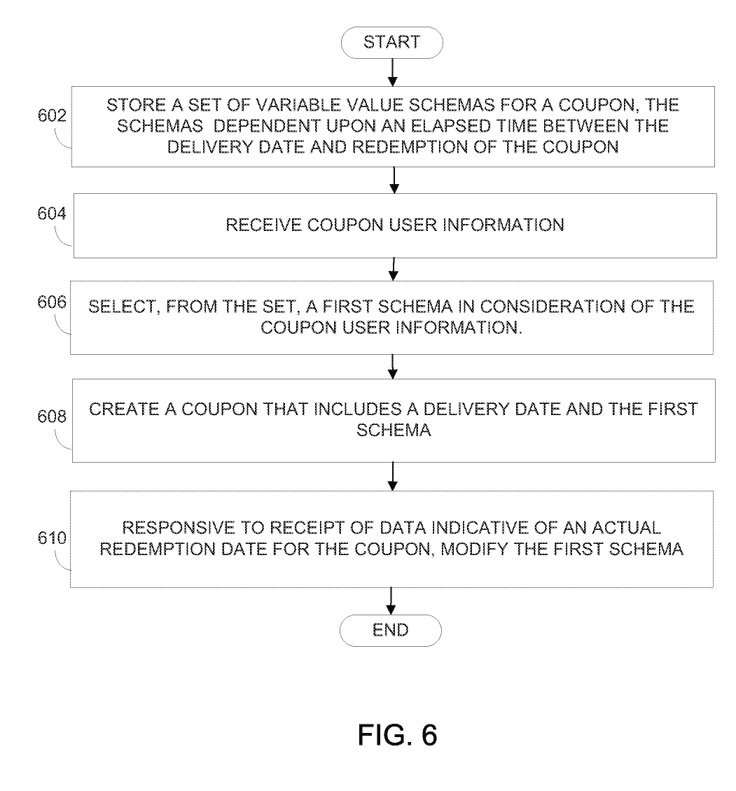

FIGS. 5 and 6 are examples of steps taken to implement various embodiments. In discussing FIGS. 5 and 6, reference may be made to the diagrams of FIGS. 1-4 to provide contextual examples. Implementation, however, is not limited to those examples. FIGS. 5 and 6 depict workflows from the perspective of a coupon management service such as coupon management service 206 of FIG. 2, coupon management service 316 of FIG. 3, and coupon management service 428 of FIG. 4.

Starting with FIG. 5, a coupon is created that includes a delivery date and data associated with a variable value schema. The variable value schema is dependent upon an elapsed time between the delivery date and redemption of the coupon (block 502). Referring back to FIG. 1, the coupon creation module 102 may be responsible for implementing block 502.

Moving to FIG. 6, a set of variable value schemas for a coupon is stored. The schemas are dependent upon an elapsed time between the delivery date and redemption of the coupon (block 602). Referring back to FIG. 1, the schema selection module 104 may be responsible for implementing block 602.

Continuing with the flow diagram of FIG. 6, coupon user information is received (block 604). Referring back to FIG. 1, the schema selection module 104 may be responsible for implementing block 604.

Continuing with the flow diagram of FIG. 6, a first schema is selected from the set in consideration of the coupon user information (block 606). Referring back to FIG. 1, the schema selection module 104 may be responsible for implementing block 606.

Continuing with the flow diagram of FIG. 6, a coupon is created that includes a delivery date and data associated with the first schema (block 608). Referring back to FIG. 1, the coupon creation module 102 may be responsible for implementing block 608.

Continuing with the flow diagram of FIG. 6, the first schema is modified responsive to receipt of data indicative of an actual redemption date for the coupon (block 610). Referring back to FIG. 1, the modification module 106 may be responsible for implementing block 610.

Although the flow diagrams of FIGS. 5 and 6 show specific orders of execution, the orders of execution may differ from that which is depicted. For example, the order of execution of two or more blocks may be scrambled relative to the order shown. Also, two or more blocks shown in succession may be executed concurrently or with partial concurrence. All such variations are within the scope of the present disclosure.

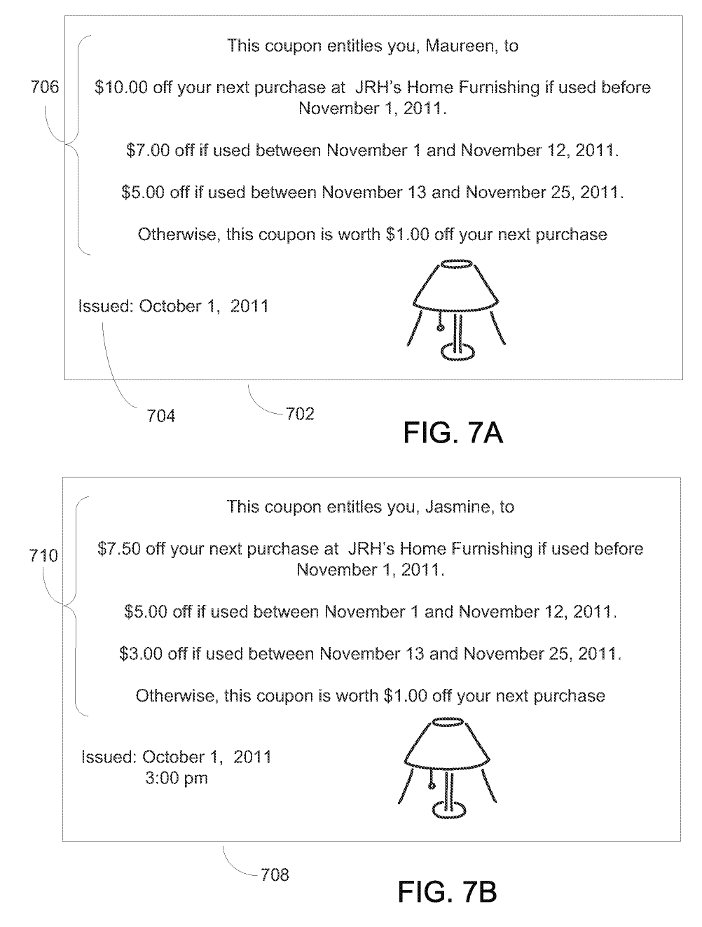

FIG. 7A provides an example of a variable value coupon 702. In this example, coupon 702 includes a delivery date 704 and a variable value schema 706 that appears as text on the fact of the coupon 702. In this example, coupon user Maureen was sent a coupon on Oct. 1, 2011, which coupon has a variable redemption value depending upon elapsed time between the Oct. 1, 2011 delivery date 704 and the data the coupon is redeemed. The variable value schema 706 establishes that the coupon's redemption value is $10.00 if used before Nov. 1, 2011, $7.00 if used between Nov. 1 and Nov. 12, 2011, and $5.00 if used between Nov. 13 and Nov. 25, 2011. If used after Nov. 25, 2011, the coupon has a redemption value of $1.00. Coupon 702 may additionally include an encoded version of the delivery date and variable value schema data in a barcode format, such that a redeeming entity can utilize an electronic device to read the barcode and efficiently determine the redemption value based upon the elapsed time between the delivery date 704 and the redemption date.

Moving to FIG. 7B, a second coupon 708 is illustrated that is substantially the same as the first coupon 702 presented in FIG. 7A. The difference in the coupons is that this coupon was delivered at 3:00 pm Oct. 1, 2011 to Jasmine with a variable value schema 710 that contains lower redemption values than does the coupon created for Maureen (702, FIG. 7A). The variable value schema that contains the lower redemption values was selected from a library of available schemas, in consideration of one of, or a combination of, coupon user information in the form of demographic data, transaction history data, location data, market data and inventory data. In an example, this variable value schema 710 may have been chose for coupon user Jasmine based upon a transaction history suggesting that Jasmine is likely to redeem the coupon promptly without the higher incentives present in the variable value coupon 702 of FIG. 7A.

The present disclosure may be embodied in any computer-readable media for use by or in connection with an instruction execution system such as a computer/processor based system or an ASIC (Application Specific Integrated Circuit) or other system that can fetch or obtain the logic from computer-readable media and execute the instructions contained therein.

The preceding description has been presented only to illustrate and describe embodiments and examples of the principles described. This description is not intended to be exhaustive or to limit these principles to any precise form disclosed. Many modifications and variations are possible in light of the above teaching.

What is claimed is:

1. A method to create a variable value coupon, comprising the steps of:
creating a coupon, the coupon including:
a delivery date, and
data associated with a variable value schema, the schema dependent upon an elapsed time between the delivery date and redemption of the coupon.

2. The method of claim 1, wherein the data in the creating step comprises the variable value schema.

3. The method of claim 1, wherein the data in the creating step comprises an address for electronic access to the schema.

4. The method of claim 1, wherein the schema in the creating step comprises at least one of a formula or lookup table.

5. The method of claim 1, further comprising the steps of:
storing a plurality of variable value schemas for the coupon;
receiving coupon user information;
selecting, from the plurality of schemas, the first schema in consideration of the information.

6. The method of claim 5, wherein the information in the receiving coupon user information and selecting steps comprises at least one of demographic information, transaction history information, or a location of a coupon user.

7. The method of claim 5,
further comprising the step of receiving market information or inventory information, and
wherein the selecting step is performed in consideration of the market information or the inventory information.

8. The method of claim 5, wherein the information in the receiving coupon user information step and selecting steps is information relating to a printer.

9. The method of claim 5, wherein the information in the receiving coupon user information and selecting steps is information obtained via a web-enabled printer.

10. The method of claim 5, wherein the information in the receiving coupon user information and selecting steps is information obtained via a coupon user's interaction with a web application.

11. The method of claim 1, further comprising the step of printing the coupon.

12. The method of claim 1, further comprising the step of sending the coupon to a computing device.

13. The method of claim 1, wherein the coupon comprises at least one of the delivery date, the schema, or the address, in an encoded format.

14. The method of claim 13, wherein the encoded format in the creating step comprises at least one of a barcode, a two-dimensional barcode, or a digital watermark.

15. The method of claim 1, further comprising the step of responsive to receiving data indicative of an actual redemption date for the coupon, modifying the schema.

16. The method of claim 1, further comprising the step of responsive to receiving data indicative of an actual redemption date for the coupon, modifying the coupon user information.

17. A system to produce a variable value coupon, comprising:
a coupon creation module, configured to deliver a coupon, the coupon including
a delivery date, and
data associated with a variable value schema, the schema dependent upon an elapsed time between the delivery date and redemption of the coupon.

18. The system of claim 17, further comprising a selection module, configured to:
store a plurality of variable value schemes for the coupon;
receive information comprising at least one of coupon user information, market information, or inventory information;
select, from the plurality of schemas, the first schema in consideration of the information.

19. The system of claim 17, wherein the coupon creation module is configured to at least one of print the coupon or send the coupon to a computing device.

20. The system of claim 17, wherein the coupon creation module is configured to deliver the coupon including at least one of the delivery date, an address for electronic access to the schema, or the schema in an encoded format.

21. The system of claim 17, further comprising a modification module, configured to, responsive to receiving data indicative of an actual redemption date for the coupon, modify the schema or the coupon user information.

22. The system of claim 17, wherein the schema comprises at least one of a formula or a lookup table.

23. A computer-readable storage medium containing instructions for creation of a variable value coupon, the instructions when executed by a processor causing the processor to:
store a set of variable value schemes for a coupon, the schemes dependent upon an elapsed time between the delivery date and redemption of the coupon;
receive coupon user information;
select, from the set, a first schema in consideration of the coupon user information;
create a coupon that includes a delivery date and the first schema;
modify the first schema responsive to receipt of data indicative of an actual redemption date for the coupon.
